(19) United States
(12) Patent Application Publication
(10) Pub. No.: US 2019/0200148 A1
(43) Pub. Date: Jun. 27, 2019

(54) AUDIO DEVICE HAVING ACTIVE NOISE CANCELLATION FUNCTION AND METHOD OF CORRECTING TEMPERATURE CHARACTERISTICS THEREOF

(71) Applicant: CESIGN CO., LTD., Seongnam-si (KR)

(72) Inventor: Soo Hyoung LEE, Hwaseong-si (KR)

(21) Appl. No.: 16/190,501

(22) Filed: Nov. 14, 2018

(30) Foreign Application Priority Data
Dec. 26, 2017 (KR) 10-2017-0179068

(51) Int. Cl. H04R 29/00; H04R 1/40; H04R 3/00

(52) U.S. Cl. CPC H04R 29/006; H04R 3/005; H04R 1/406

(57) ABSTRACT

Provided is a method of correcting temperature characteristics of an audio device that includes a first microphone and a second microphone, including: measuring a temperature of the first microphone at a step (a-1); correcting an output signal of the first microphone at a step (b-1) using the measured temperature at the step (a-1); and calculating an output signal of the audio device at a step (c) using the corrected output signal of the first microphone at the step (b-1).

### BACKGROUND OF THE INVENTION

### Field of the Invention

The present invention relates generally to an audio device having an active noise cancellation function and a method of correcting temperature characteristics of the audio device.

### Description of the Related Art

An active noise cancellation method may use feedback control, feed-forward control, or hybrid control which is a combination of feedback control and feed-forward control.

In feedback control, noise signals are received by using a first microphone that is located outside a headset or ear capsules, such as earphones, or the like, and noise is canceled. In feed-forward control, playback audio signals and noise are simultaneously received and processed using a second microphone located inside the headset or ear capsules, such as earphones, or the like, and noise is canceled.

Feedback control and feed-forward control differ in frequency characteristics of noise cancellation, so that recently, hybrid control which is a combination of the feedback control and feed-forward control is commonly used.

In hybrid control, noise is canceled using two microphones. However, there may exist a large difference in temperature between the first microphone, which is located outside the ear capsule for the feedback control, and the second microphone, which is located inside the ear capsule for feed-forward control, thus causing sound transmission characteristics of each microphone to be changed. Accordingly, it is necessary to solve this problem.

The foregoing is intended merely to aid in the understanding of the background of the present invention, and is not intended to mean that the present invention falls within the purview of the related art that is already known to those skilled in the art.

### DOCUMENT OF RELATED ART

(Patent Document 1) Korean Patent Application Publication No. 10-2015-0008471: Frequency and direction-dependent ambient sound handling in personal audio devices having adaptive noise cancellation (published Jan. 22, 2015).

### SUMMARY OF THE INVENTION

Accordingly, the present invention has been made keeping in mind the above problems occurring in the related art, and the present invention is intended to propose an audio device having an active noise cancellation function and a method of correcting temperature characteristics of the audio device, the method and device being capable of correcting a difference between output signals according to a temperature by detecting temperatures of two microphones.

In order to achieve the above object, according to one aspect of the present invention, there is provided a method of correcting temperature characteristics of an audio device that includes a first microphone and a second microphone, the method including: measuring a temperature of the first microphone at a step (a-1); correcting an output signal of the first microphone at a step (b-1) using the measured temperature at the step (a-1); and calculating an output signal of the audio device at a step (c) using the corrected output signal of the first microphone at the step (b-1). Specifically, in the measuring of the temperature of the first microphone at the step (a-1), a temperature sensor may be used or thermal properties of a can surrounding the first microphone may be used.

Furthermore, at the step (c), an output signal of the second microphone may be intactly used without correction.

Also, the method of correcting temperature characteristics of the audio device of the present invention may further include: measuring a temperature of the second microphone at a step (a-2); and correcting an output signal of the second microphone at a step (b-2) using the measured temperature at the step (a-2), wherein at the step (c), the output signal of the audio device is calculated using the corrected output signal of the second microphone at the step (b-2).

Furthermore, at the step (b-2), the output signal of the second microphone may be corrected using a second correction value that is a correction coefficient value at the measured temperature of the second microphone.

At the step (b-1), the output signal of the first microphone may be corrected using a first correction value that is a correction coefficient value at the measured temperature of the first microphone.

According to another aspect of the present invention, there is provided an audio device including: a first microphone; a second microphone; a first correction unit correcting an output signal of the first microphone using a measured temperature of the first microphone; and an output unit calculating and outputting an output signal of the audio device using the corrected output signal of the first microphone by the first correction unit.

Specifically, regarding the measured temperature of the first microphone, a temperature sensor may be used or thermal properties of a can surrounding the first microphone may be used.

Also, the output unit may intactly use an output signal of the second microphone without correction.

Furthermore, the audio device of the present invention may further include: a second correction unit correcting an output signal of the second microphone using a measured temperature of the second microphone, wherein the output unit may calculate and output the output signal of the audio device using the corrected output signal of the second microphone by the second correction unit. Here, the second correction unit may correct the output signal of the second microphone into an output signal at a first temperature using a second correction value that is a correction coefficient value at the measured temperature of the second microphone.

Also, the first correction unit may correct the output signal of the first microphone into an output signal at a first temperature using a first correction value that is a correction coefficient value at the measured temperature of the first microphone.

According to the audio device having the active noise cancellation function and the method of correcting temperature characteristics of the audio device of the present invention, a difference between output signals according to a temperature is corrected by detecting temperatures of two microphones.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a configuration diagram illustrating an audio device having an active noise cancellation function according to a first exemplary embodiment of the present invention;

FIG. 2 is a diagram illustrating arrangement of a first microphone and a second microphone;

FIG. 3 is a diagram illustrating computation of the audio device having the active noise cancellation function according to the first exemplary embodiment of the present invention;

FIG. 4 is a configuration diagram illustrating an audio device having an active noise cancellation function according to a second exemplary embodiment of the present invention;

FIG. 5 is a diagram illustrating computation of the audio device having the active noise cancellation function according to the second exemplary embodiment of the present invention;

FIG. 6 is a flowchart illustrating a method of correcting temperature characteristics of the audio device having the active noise cancellation function according to the first exemplary embodiment of the present invention; and

FIG. 7 is a flowchart illustrating a method of correcting temperature characteristics of the audio device having the active noise cancellation function according to the second exemplary embodiment of the present invention.

### DETAILED DESCRIPTION OF THE INVENTION

Hereinafter, an audio device having an active noise cancellation function and a method of correcting temperature characteristics of the audio device according to embodiments of the present invention will be described in detail with reference to the accompanying drawings.

It is noted that the embodiments of the present invention are illustrative of the present invention and do not limit the scope of the present invention. It should be appreciated that those skilled in the art, on consideration of this disclosure, may make modifications and improvements within the spirit and scope of the present invention.

An audio device 100 or 200 of the present invention performs feedback control and feed-forward control using signals output from a first microphone M1 and a second microphone M2 in such a manner as to cancel noise and output sound to a speaker. Examples of the audio device 100 or 200 of the present invention include a device, such as earphones, a headset, or the like.

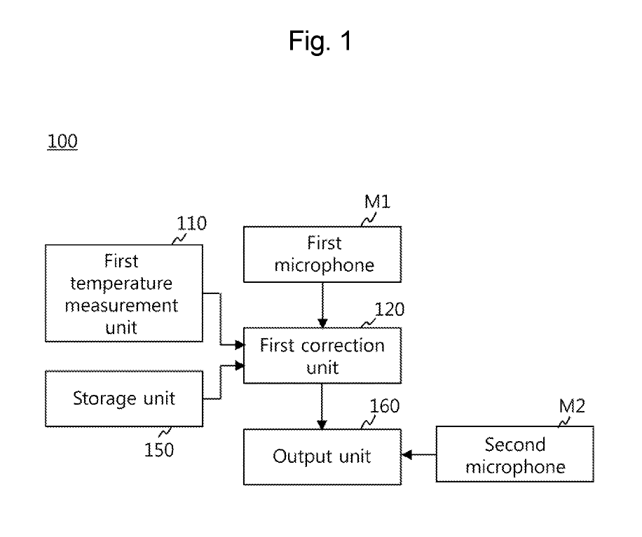

First, FIG. 1 is a configuration diagram illustrating an audio device 100 having an active noise cancellation function according to a first exemplary embodiment of the present invention.

As shown in FIG. 1, according to the first exemplary embodiment of the present invention, the audio device 100 having the active noise cancellation function includes: the first microphone M1; the second microphone M2; a first temperature measurement unit 110; a first correction unit 120; a storage unit 150; and an output unit 160.

The first correction unit 120 and the output unit 160 may be individually implemented using at least a part of a processor, such as a digital signal processor (DSP), a circuit, and/or a combination of the processor and the circuit. The storage unit 150 may use a memory, or the like.

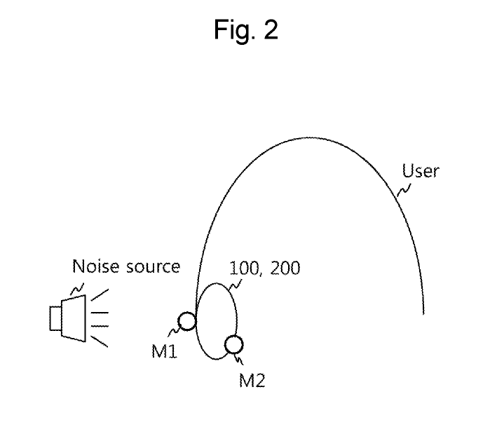

FIG. 2 is a diagram illustrating arrangement of the first microphone M1 and the second microphone M2.

As shown in FIG. 2, regarding the first microphone M1 and the second microphone M2, when wearing the audio device 100 or 200, the microphone M1 is positioned outside the user's ear and the second microphone M2 is positioned toward the inside of the user's ear. That is, the second microphone M2 is positioned closer to the inside of the user's ear than the first microphone M1.

Generally, a microphone is a capacitive structure, so that sound transmission characteristics of the microphone vary according to a temperature. Accordingly, the first microphone M1 is directly exposed to the outside, so that a difference occurs in output characteristics depending on the temperature. However, the second microphone M2 is positioned toward the inside of the user's ear, so that there is little difference that occurs in the output characteristics depending on the temperature. That is, it is assumed that the temperature of the second microphone M2 is a constant temperature of about 37 degrees Celsius.

The first temperature measurement unit 110 measures the temperature of the first microphone M1. Specifically, the first temperature measurement unit 110 may use a temperature sensor, such as a thermistor, or a can of the first microphone M1. In the case of using the temperature sensor, the temperature sensor may be provided in the first microphone M1, or may be positioned near the first microphone M1 outside the ear.

The can is also referred to as a shield can. Thermal properties of the can are used to measure the temperature of the first microphone M1. The can is made of a metal, such as aluminum, or the like, with high heat conduction properties. Heat is transferred to a separate pad being in contact with this can, and thermal properties are converted into electrical signals using a circuit, such as a bandgap voltage reference, whereby the temperature of the first microphone M1 is measured.

The first correction unit 120 corrects the output signal of the first microphone M1 using the temperature of the first microphone M1, which is measured by the first temperature measurement unit 110.

Specifically, the first correction unit 120 corrects the output signal of the first microphone M1 into the output signal at a first temperature using a first correction value which is a correction coefficient value at the measured temperature of the first microphone M1. The first temperature may be set to normal human body temperature, for example, 37 degrees Celsius. The storage unit 150 stores correction coefficients for the output signals of the first microphone M1 according to the temperature in the form of a lookup table in such a manner that the first correction unit 120 uses the correction coefficients.

The output signal of the first microphone M1 may be corrected by the first correction unit 120 as shown in Equation 1 below and may be output.

SIG1′=α1×SIG1 [Equation 1]

In Equation 1, SIG1′ denotes the corrected output signal of the first microphone M1, SIG1 denotes the uncorrected output signal of the first microphone M1, and α1 denotes the first correction value which is the correction coefficient value at the measured temperature. The first correction value which is the correction coefficient value at the measured temperature may be get from the correction coefficient stored in the storage unit 150, or may be calculated by interpolating or extrapolating the correction coefficient stored in the storage unit 150. The first correction value which is the correction coefficient value at the measured temperature varies according to a difference in temperature between the measured temperature and the first temperature. For example, when the measured temperature is the same as the first temperature, the first correction value which is the correction coefficient value at the measured temperature is “one”.

The output unit 160 calculates and outputs the output signal of the audio device 100 using the corrected output signal of the first microphone M1 by the first correction unit 120.

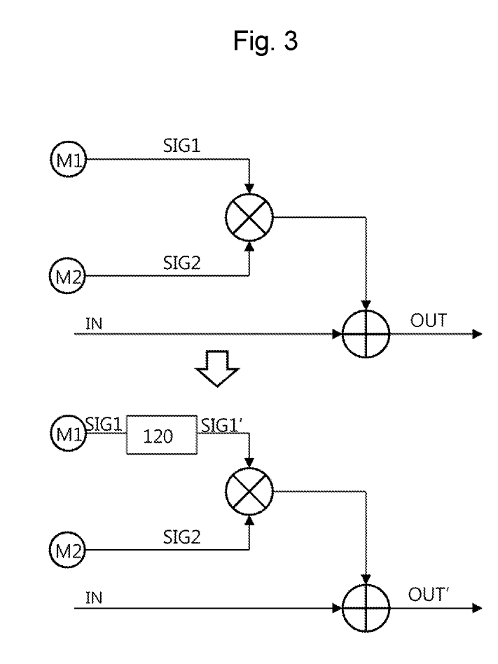

FIG. 3 is a diagram illustrating computation of the audio device 100 having the active noise cancellation function according to the first exemplary embodiment of the present invention. If the first correction unit 120 is not present, the output unit 160 outputs a signal as shown in Equation 2 below.

OUT=IN+(SIG1×SIG2) [Equation 2]

In Equation 2, OUT denotes the output signal of the output unit 160 when there is no correction, IN denotes the input signal, SIG1 denotes the uncorrected output signal of the first microphone M1, and SIG2 denotes the uncorrected output signal of the second microphone M2.

According to the first exemplary embodiment of the present invention, when the first correction 120 is present, the output unit 160 outputs a signal as shown in Equation 3 below.

OUT=IN+(SIG1′×SIG2) [Equation 3]

In Equation 3, OUT′ denotes the output signal of the output unit 160 when there is correction, IN denotes the input signal, SIG1′ denotes the corrected output signal of the first microphone M1, and SIG2 denotes the uncorrected output signal of the second microphone M2. Regarding the second microphone M2, since normal human body temperature is assumed, the output thereof is intactly used without any correction in the first exemplary embodiment of the present invention.

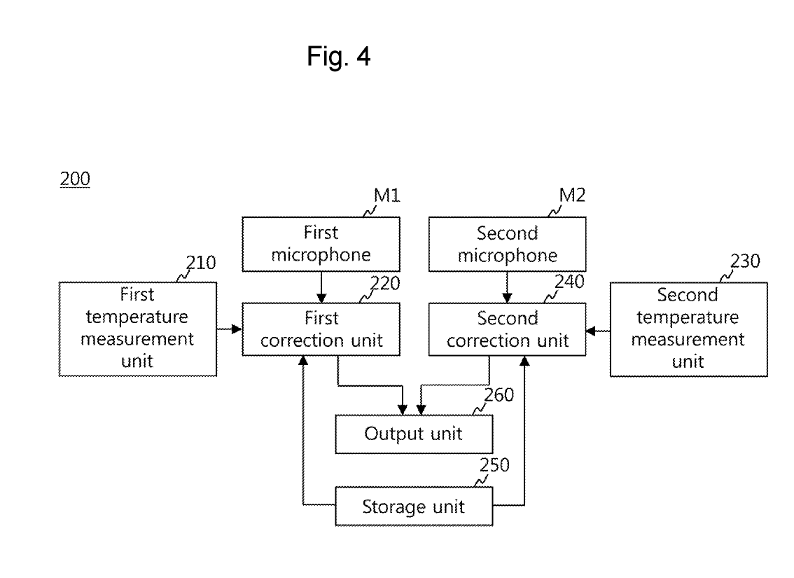

FIG. 4 is a configuration diagram illustrating an audio device 200 having an active noise cancellation function according to a second exemplary embodiment of the present invention.

As shown in FIG. 4, according to the second exemplary embodiment of the present invention, the audio device 200 having the active noise cancellation function includes: a first microphone M1; a second microphone M2; a first temperature measurement unit 210; a first correction unit 220; a second temperature measurement unit 230; a second correction unit 240; a storage unit 250; and an output unit 260.

Even though there is no description, the audio device 200 having the active noise cancellation function according to the second exemplary embodiment of the present invention includes all the features of the audio device 100 having the active noise cancellation function according to the first exemplary embodiment of the present invention. However, there is a difference in that the temperature of the second microphone M2 is measured by the second temperature measurement unit 230 and the characteristics of the second microphone M2 are corrected by the second correction unit 240.

The first correction unit 220, the second correction unit 240, and the output unit 260 may be individually implemented using at least a part of a processor, such as a digital signal processor (DSP), a circuit, and/or a combination of the processor and the circuit. The storage unit 250 may use a memory, or the like.

As shown in FIG. 2, regarding the first microphone M1 and the second microphone M2, when wearing the audio device 100 or 200, the microphone M1 is positioned outside the user's ear and the second microphone M2 is positioned toward the inside of the user's ear. That is, the second microphone M2 is positioned closer to the inside of the user's ear than the first microphone M1.

Generally, a microphone is a capacitive structure, so that sound transmission characteristics of the microphone vary according to a temperature. Accordingly, the first microphone M1 is directly exposed to the outside, so that a difference occurs in output characteristics depending on the temperature. However, the second microphone M2 is positioned toward the inside of the user's ear, so that there is little difference that occurs in the output characteristics depending on the temperature. However, in the second exemplary embodiment of the present invention, the temperature of the second microphone M2 is measured separately.

The first temperature measurement unit 210 measures the temperature of the first microphone M1. Specifically, the first temperature measurement unit 210 may use a temperature sensor, such as a thermistor, or a can of the first microphone M1. In the case of using the temperature sensor, the temperature sensor may be provided in the first microphone M1, or may be positioned near the first microphone M1 outside the ear.

The second temperature measurement unit 230 measures the temperature of the second microphone M2. Specifically, the second temperature measurement unit 230 may use a temperature sensor, such as a thermistor, or a can of the second microphone M2. In the case of using the temperature sensor, the temperature sensor may be provided in the second microphone M2, or may be positioned near the second microphone M2 outside the ear.

The can is also referred to as a shield can. Thermal properties of the can are used to measure the temperature of the first microphone M1. The can is made of a metal, such as aluminum, or the like, with high heat conduction properties. Heat is transferred to a separate pad being in contact with this can, and thermal properties are converted into electrical signals using a circuit, such as a bandgap voltage reference, whereby the temperature of the first microphone M1 or the second microphone M2 or both are measured.

The first correction unit 220 corrects the output signal of the first microphone M1 using the temperature of the first microphone M1, which is measured by the first temperature measurement unit 210.

Specifically, the first correction unit 220 corrects the output signal of the first microphone M1 into the output signal at a first temperature using a first correction value which is a correction coefficient value at the measured temperature of the first microphone M1. The first temperature may be set to normal human body temperature, for example, 37 degrees Celsius. The storage unit 250 stores correction coefficients for the output signals of the first microphone M1 according to the temperature in the form of a lookup table in such a manner that the first correction unit 220 uses the correction coefficients.

The output signal of the first microphone M1 may be corrected by the first correction unit 220 as shown in Equation 4 below and may be output.

SIG1′=α1×SIG1 [Equation 4]

In Equation 4, SIG1′ denotes the corrected output signal of the first microphone M1, SIG1 denotes the uncorrected output signal of the first microphone M1, and α1 denotes the first correction value which is the correction coefficient value at the measured temperature. The first correction value which is the correction coefficient value at the measured temperature may be get from the correction coefficient stored in the storage unit 250, or may be calculated by interpolating or extrapolating the correction coefficient stored in the storage unit 250 according to the temperature value. The first correction value which is the correction coefficient value at the measured temperature varies according to a difference in temperature between the measured temperature and the first temperature. For example, when the measured temperature is the same as the first temperature, the first correction value which is the correction coefficient value at the measured temperature is “one”.

The second correction unit 240 corrects the output signal of the second microphone M2 using the temperature of the second microphone M2, which is measured by the second temperature measurement unit 230.

Specifically, the second correction unit 240 corrects the output signal of the second microphone M2 into the output signal at a first temperature using a second correction value which is a correction coefficient value at the measured temperature of the second microphone M2. The first temperature may be set to normal human body temperature, for example, 37 degrees Celsius. The storage unit 250 stores correction coefficients for the output signals of the second microphone M2 according to the temperature in the form of a lookup table in such a manner that the second correction unit 240 uses the correction coefficients. The second correction value which is the correction coefficient value at the measured temperature varies according to a difference in temperature between the measured temperature and the first temperature. For example, when the measured temperature is the same as the first temperature, the second correction value which is the correction coefficient value at the measured temperature is “one”.

The output signal of the second microphone M2 may be corrected by the second correction unit 240 as shown in Equation 5 below and may be output.

SIG2′=α2×SIG2 [Equation 5]

In Equation 5, SIG2′ denotes the corrected output signal of the second microphone M2, SIG2 denotes the uncorrected output signal of the second microphone M2, and α2 denotes the second correction value which is the correction coefficient value at the measured temperature. The second correction value which is the correction coefficient value at the measured temperature may be get from the correction coefficient stored in the storage unit 250, or may be calculated by interpolating or extrapolating the correction coefficient stored in the storage unit 250.

The output unit 260 calculates and outputs the output signal of the audio device 200 using the corrected output signal of the first microphone M1 by the first correction unit 220 and the corrected output signal of the second microphone M2 by the second correction unit 240.

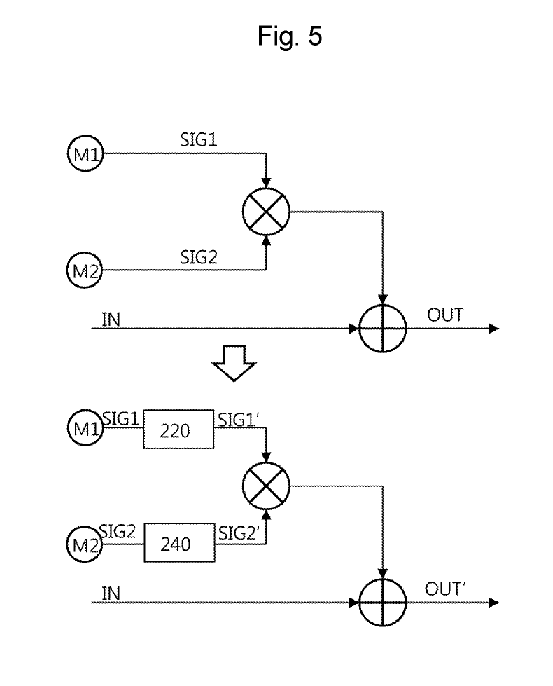

FIG. 5 is a diagram illustrating computation of the audio device 200 having the active noise cancellation function according to the second exemplary embodiment of the present invention. As shown in FIG. 5, according to the second exemplary embodiment of the present invention, the output unit 260 outputs a signal as shown in Equation 6 below.

OUT′=IN+(SIG1′×SIG2′) [Equation 6]

In Equation 6, OUT′ denotes the output signal of the output unit 260 when there is correction, IN denotes the input signal, SIG1′ denotes the corrected output signal of the first microphone M1, and SIG2′ denotes the corrected output signal of the second microphone M2.

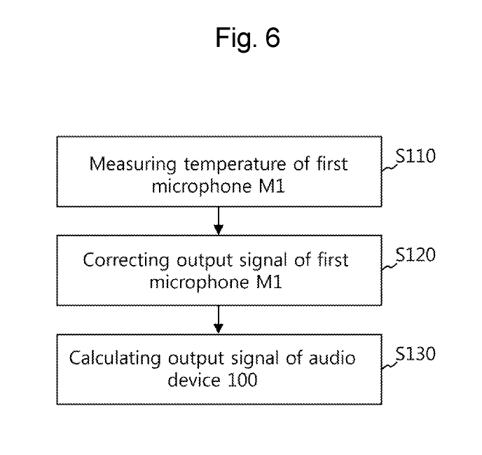

FIG. 6 is a flowchart illustrating a method of correcting temperature characteristics of the audio device having the active noise cancellation function according to the first exemplary embodiment of the present invention.

Since the audio device 100 having the active noise cancellation function according to the first exemplary embodiment of the present invention is used in the method of correcting temperature characteristics of the audio device having the active noise cancellation function according to the first exemplary embodiment of the present invention, even though there is no description, all the features of the audio device 100 having the active noise cancellation function according to the first exemplary embodiment of the present invention are included.

As shown in FIG. 6, the method of correcting temperature characteristics of the audio device having the active noise cancellation function according to the first exemplary embodiment of the present invention includes: measuring the temperature of the first microphone M1 at step S110; correcting the output signal of the first microphone M1 at step S120 using the measured temperature at step S110; and calculating the output signal of the audio device 100 at step S130 using the corrected output signal of the first microphone M1 at step S120.

In the measuring of the temperature of the first microphone M1 at step S110, the temperature sensor is used or thermal properties of the can surrounding the first microphone M1 are used. Furthermore, at step S120, it is desirable that the output signal of the first microphone M1 is corrected using the first correction value which is the correction coefficient value at the measured temperature of the first microphone M1.

Also, at step S130, the output signal of the second microphone M2 is intactly used without correction.

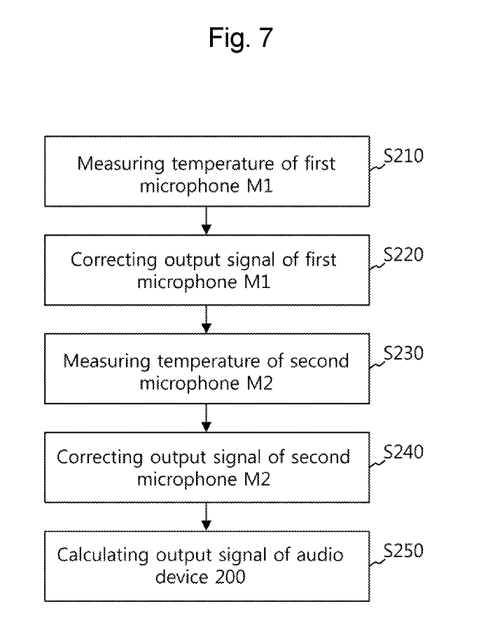

FIG. 7 is a flowchart illustrating a method of correcting temperature characteristics of the audio device having the active noise cancellation function according to the second exemplary embodiment of the present invention.

Since the audio device 200 having the active noise cancellation function according to the second exemplary embodiment of the present invention is used in the method of correcting temperature characteristics of the audio device having the active noise cancellation function according to the second exemplary embodiment of the present invention, even though there is no description, all the features of the audio device 200 having the active noise cancellation function according to the second exemplary embodiment of the present invention are included.

As shown in FIG. 7, the method of correcting temperature characteristics of the audio device 200 having the active noise cancellation function according to the second exemplary embodiment of the present invention includes: measuring the temperature of the first microphone M1 S210; correcting the output signal of the first microphone M1 at step S220 using the measured temperature at step S210; measuring the temperature of the second microphone M2 at step S230; correcting the output signal of the second microphone M2 at step S240 using the measured temperature at step S230; and calculating the output signal of the audio device 200 at step S250 using the corrected output signal of the first microphone M1 at step S220 and the corrected output signal of the second microphone M2 at step S240.

In the measuring of the temperature of the first microphone M1 at step S210, the temperature sensor is used or thermal properties of the can surrounding the first microphone M1 are used. Furthermore, at step S220, it is desirable that the output signal of the first microphone M1 is corrected using the first correction value which is the correction coefficient value at the measured temperature of the first microphone M1.

In the measuring of the temperature of the second microphone M2 at step S230, the temperature sensor is used or thermal properties of the can surrounding the second microphone M2 are used. Furthermore, at step 240, the output signal of the second microphone M2 is corrected using the second correction value which is the correction coefficient value at the measured temperature of the second microphone M2.

As described above, according to the audio device 100 or 200 having the active noise cancellation function and the method of correcting temperature characteristics of the audio device 100 or 200, by correcting the output of the first microphone M1 and the output of the second microphone M2 into the outputs of the same temperature, the output of the audio device 100 or 200 is prevented from varying according to the difference in temperature between the first microphone M1 and the second microphone M2.

That is, according to the audio device 100 or 200 having the active noise cancellation function and the method of correcting temperature characteristics of the audio device 100 or 200, a difference between output signals according to the temperature is corrected by detecting temperatures of two microphones.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of correcting temperature characteristics of an audio device that includes a first microphone and a second microphone, the method comprising:
measuring a temperature of the first microphone at a step (a-1);
correcting an output signal of the first microphone at a step (b-1) using the measured temperature at the step (a-1); and
calculating an output signal of the audio device at a step (c) using the corrected output signal of the first microphone at the step (b-1).

2. The method of claim 1, wherein in the measuring of the temperature of the first microphone at the step (a-1), a temperature sensor is used or thermal properties of a can surrounding the first microphone are used.

3. The method of claim 1, wherein at the step (c), an output signal of the second microphone is intactly used without correction.

4. The method of claim 1, further comprising:
measuring a temperature of the second microphone at a step (a-2); and
correcting an output signal of the second microphone at a step (b-2) using the measured temperature at the step (a-2),
wherein at the step (c), the output signal of the audio device is calculated using the corrected output signal of the second microphone at the step (b-2).

5. The method of claim 4, wherein at the step (b-2), the output signal of the second microphone is corrected using a second correction value that is a correction coefficient value at the measured temperature of the second microphone.

6. The method of claim 1, wherein at the step (b-1), the output signal of the first microphone is corrected using a first correction value that is a correction coefficient value at the measured temperature of the first microphone.

7. An audio device comprising:
a first microphone;
a second microphone;
a first correction unit correcting an output signal of the first microphone using a measured temperature of the first microphone; and
an output unit calculating and outputting an output signal of the audio device using the corrected output signal of the first microphone by the first correction unit.

8. The audio device of claim 7, wherein regarding the measured temperature of the first microphone, a temperature sensor is used or thermal properties of a can surrounding the first microphone are used.

9. The audio device of claim 7, wherein the output unit intactly uses an output signal of the second microphone without correction.

10. The audio device of claim 7, further comprising:
a second correction unit correcting an output signal of the second microphone using a measured temperature of the second microphone,
wherein the output unit calculates and outputs the output signal of the audio device using the corrected output signal of the second microphone by the second correction unit.

11. The audio device of claim 10, wherein the second correction unit corrects the output signal of the second microphone into an output signal at a first temperature using a second correction value that is a correction coefficient value at the measured temperature of the second microphone.

12. The audio device of claim 7, wherein the first correction unit corrects the output signal of the first microphone into an output signal at a first temperature using a first correction value that is a correction coefficient value at the measured temperature of the first microphone.
